(19) United States
(12) Patent Application Publication
(10) Pub. No.: US 2019/0028909 A1
(43) Pub. Date: Jan. 24, 2019

(54) ADAPTIVE HEALTH STATUS SCORING FOR NETWORK ASSURANCE

(71) Applicant: Cisco Technology, Inc., San Jose, CA (US)

(72) Inventors: Grégory Mermoud, Veyras (CH); Jean-Philippe Vasseur, Saint Martin D'uriage (FR)

(21) Appl. No.: 15/655,153

(22) Filed: Jul. 20, 2017

(51) Int. Cl. H04W 24/08; H04L 12/24; H04L 12/801; G06N 99/00; H04W 16/18

(52) U.S. Cl. CPC H04W 24/08; H04L 41/147; H04W 16/18; H04L 47/11; G06N 99/005; H04L 41/16

(57) ABSTRACT

In one embodiment, a device receives network metrics regarding networking equipment of a network in a physical location. The device predicts a health status score for the networking equipment in the physical location using the received network metrics as input to a machine learning-based predictive scoring model. The device provides an indication of the predicted health status score in conjunction with a visualization of the physical location for display by an electronic display. The device adjusts the predictive scoring model based on feedback regarding the predicted health status score.

### TECHNICAL FIELD

The present disclosure relates generally to computer networks, and, more particularly, to health status scoring for network assurance.

### BACKGROUND

Many network assurance systems rely on predefined rules to determine the health of the network. In turn, these rules can be used to trigger corrective measures and/or notify a network administrator as to the health of the network. For instance, in an assurance system for a wireless network, one rule may comprise a defined threshold for what is considered as an acceptable number of clients per access point (AP) or the channel interference, itself. More complex rules may also be created to capture conditions over time, such as a number of events in a given time window or rates of variation of metrics (e.g., the client count, channel utilization, etc.).

Different entities may also have very different expectations regarding the health of the network. For example, retail establishments, healthcare facilities, and hotels all may have different definitions in terms of what network performance is considered ‘healthy.’ For example, a retail establishment that offers free Wi-Fi to customers as a courtesy may have a lower threshold for what is considered healthy network performance than that of a healthcare facility that transmits monitored patient readings over its network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example architecture for adaptive health status scoring in a network assurance system;

FIGS. 5A-5C illustrate example network assurance visualizations of networking equipment in a physical location;

FIGS. 6A-6D illustrate example interactions with a visualized piece of networking equipment in a network assurance system; and

FIG. 7 illustrates an example simplified procedure for adjusting a health score predictive scoring model.

### DESCRIPTION OF EXAMPLE EMBODIMENTS

### Overview

According to one or more embodiments of the disclosure, a device receives network metrics regarding networking equipment of a network in a physical location. The device predicts a health status score for the networking equipment in the physical location using the received network metrics as input to a machine learning-based predictive scoring model. The device provides an indication of the predicted health status score in conjunction with a visualization of the physical location for display by an electronic display. The device adjusts the predictive scoring model based on feedback regarding the predicted health status score.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. lA is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement (SLA) characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed SLA, whereas Internet links may either have no SLA at all or a loose SLA (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

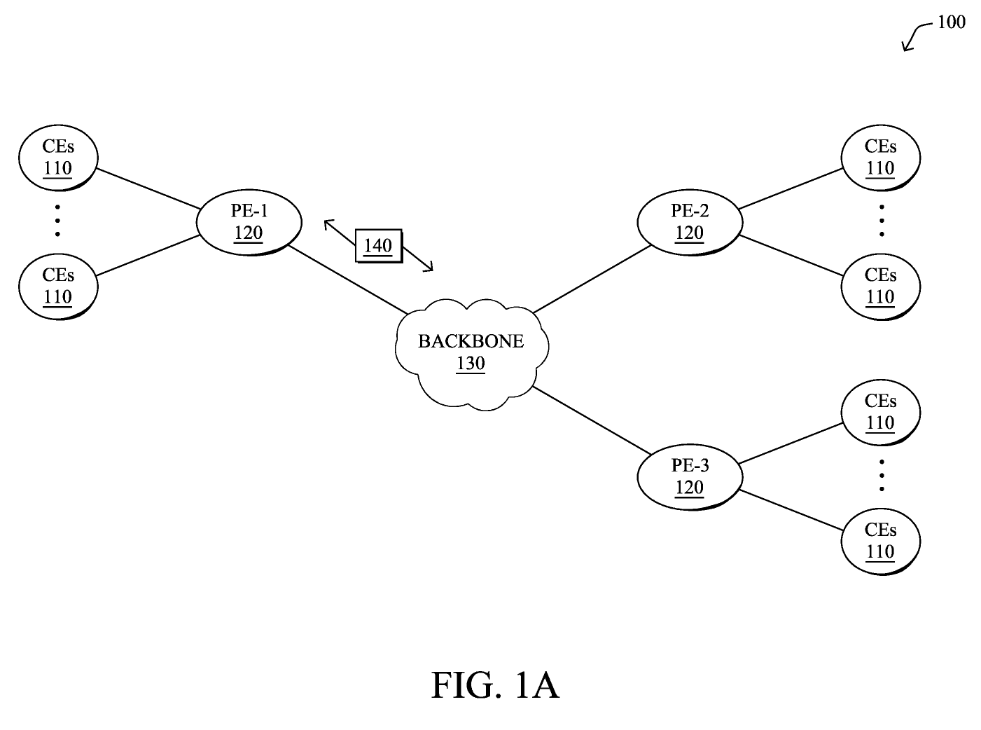

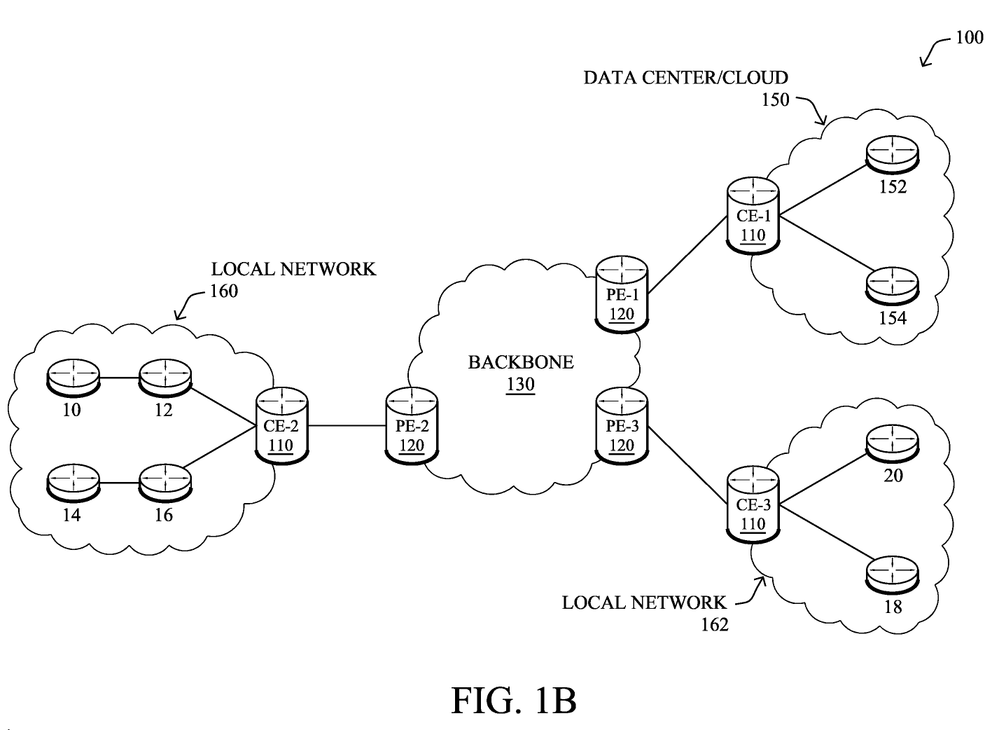

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

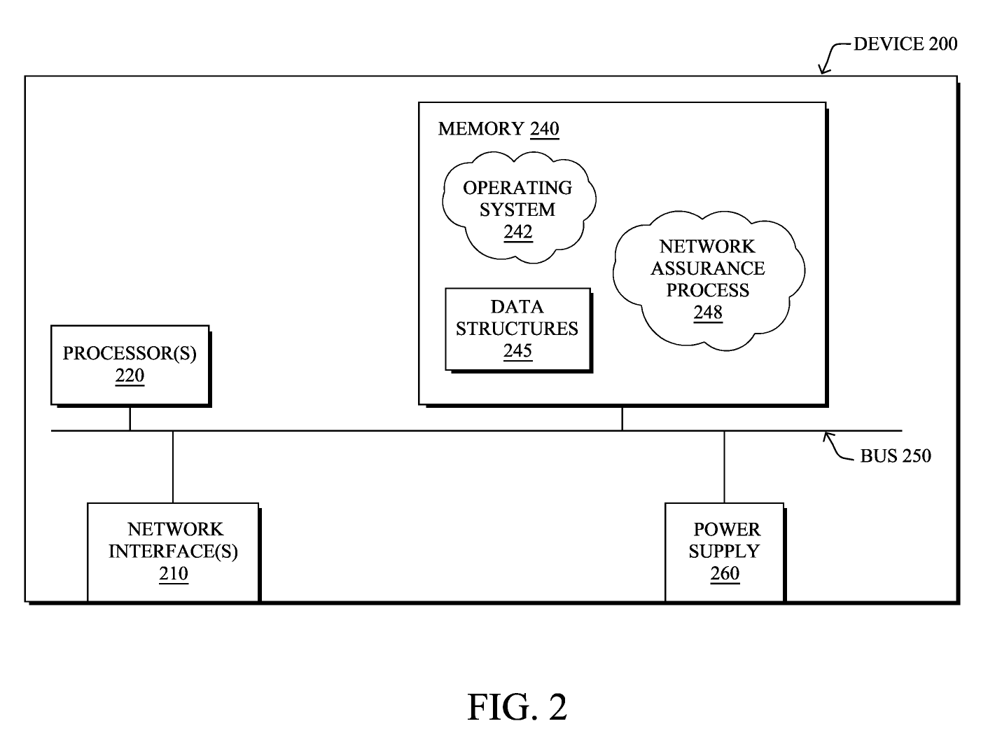

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M =a*x +b*y +c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

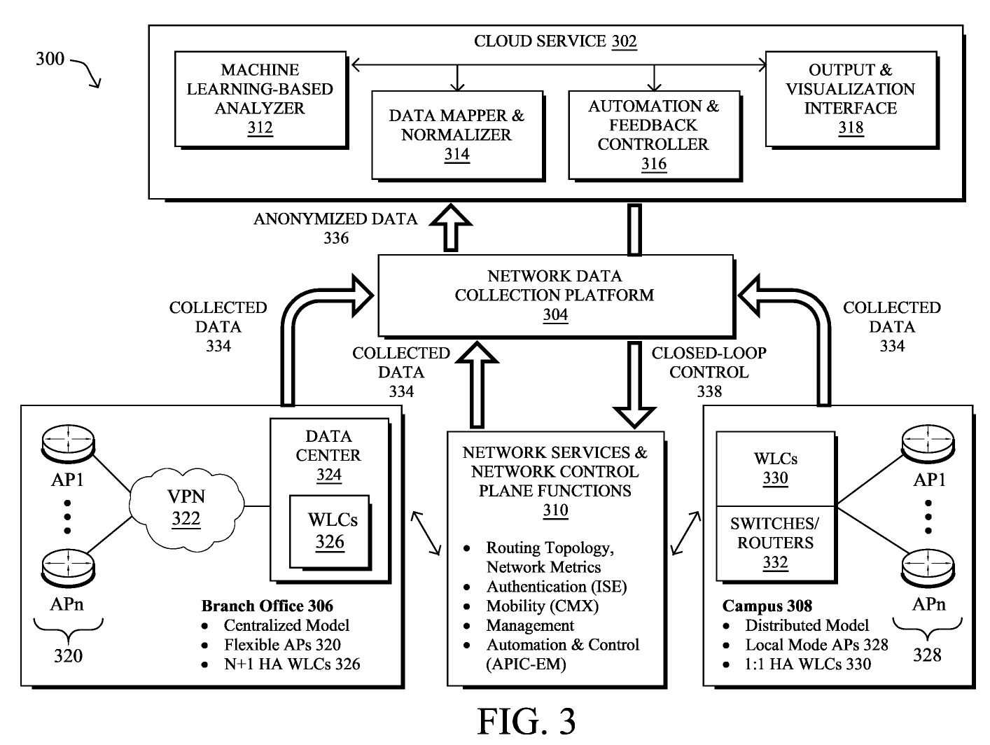

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point API through nth access point, APn) through which endpoint nodes may connect. Access points 320 may, in turn, be in communication with any number of wireless LAN controllers (WLCs) 326 located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point API through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if' scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint device, networking device in branch office 306 or campus 308, or a network service or control plane function 310, to adjust its operations (e.g., by signaling an endpoint to use a particular AP 320 or 328, etc.).

As noted above, one approach to network assurance is to predefine static health status rules. In such implementations, a simple rule may be to define a threshold for a given network metrics that, if crossed, is considered to be a health status change. For example, if the measured bandwidth consumption in the network surpasses 90%, this may be deemed an unhealthy condition, thereby triggering an alert for a network administrator to assess the situation and potentially take corrective measures. However, as networks continue to grow in size and complexity, so too have the number and complexity of the health status rules.

Further, a one-size-fits-all approach to predefining health status rules is often not possible, as different entities (e.g., retail, education, government, healthcare, entertainment, hotels, etc.) may all have very different expectations in terms of network health. Even for entities of the same type, what is considered acceptable and healthy may differ considerably (e.g., different entities may have different degrees of infrastructure investments, varying SLAs, different over-booking ratios, different network resource management strategies, etc.).

Adaptive Health Status Scoring for Network Assurance

The techniques herein introduce an adaptive health status scoring approach to network assurance that does not rely on predefined and static rules. In some aspects, the techniques herein may leverage machine learning, such as a regression model, to apply learned and adaptive health status thresholds to the monitored network as part of a predictive scoring model. Such a model may be adjusted over time based on feedback from the monitored network, users, and or administrators, thereby refining over time what is considered healthy vs. unhealthy. While these techniques are described herein primarily in the context of wireless (e.g., Wi-Fi) enterprise networks, they are equally applicable to other types of networks as well, such as wired networks, LLNs and IoT networks, cellular networks, and the like.

Specifically, according to one or more embodiments of the disclosure as described in detail below, a device receives network metrics regarding networking equipment of a network in a physical location. The device predicts a health status score for the networking equipment in the physical location using the received network metrics as input to a machine learning-based predictive scoring model. The device provides an indication of the predicted health status score in conjunction with a visualization of the physical location for display by an electronic display. The device adjusts the predictive scoring model based on feedback regarding the predicted health status score.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

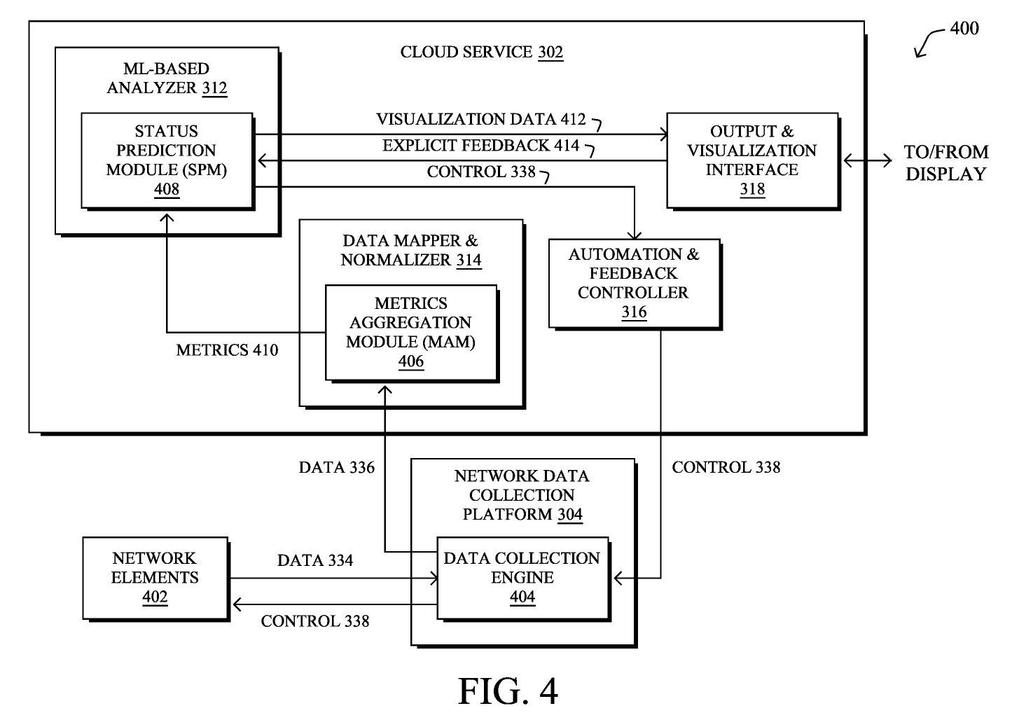

Operationally, FIG. 4 illustrates an example architecture 400 for adaptive health status scoring in a network assurance system, according to various embodiments. As shown, architecture 400 may include any or all of the following components: a metrics aggregation module (MAM) 406 and a status prediction module (SPM) 408.

In various embodiments, the components of architecture 400 may be implemented within a network assurance system, such as system 300 shown in FIG. 3. Accordingly, the components of architecture 400 shown may be implemented as part of cloud service 302, as part of network data collection platform 304, and/or on network element/data source 402 itself. For example, MAM 406 may be implemented as part of data mapper and normalizer 314 and SPM 408 may be implemented as part of machine learning(ML)-based analyzer 312, such as in the embodiment shown in FIG. 4. Further, these components may be implemented in a distributed manner or implemented as its own stand-alone service, either as part of the local network under observation or as a remote service. In addition, the functionalities of the components of architecture 400 may be combined, omitted, or implemented as part of other processes, as desired.

As shown and continuing the example of FIG. 3, a network assurance system may rely on data collection and reporting by any number of network elements/data sources 402 deployed in the local network under scrutiny. For example, a given network element 402 may be a router, switch, access point, wireless controller (e.g., WLC, etc.), or any other form of networking equipment configured to collect and report collected data 334 regarding the monitored network to a data collection engine 404 in network data collection platform 304. In turn, the data collection engine 404 may provide the collected data (e.g., collected data 334) anonymized data 336 to data mapper and normalizer 314 in cloud service 302. As would be appreciated, the anonymization of collected data 334 by data collection engine 404 may be optional, in some embodiments.

In various embodiments, architecture 400 may include metrics aggregation module 406, which is responsible for aggregating various collected metrics of interest from the underlying network infrastructure (e.g., data 336). These metrics range from wireless or wired network events (e.g. joining, (fast/slow) roaming times), to network performance metrics (e.g., measured throughput collected via SNMP or JSON files, to the results of active network probing related to delays associated with key servers in the monitored network or on the Internet (e.g., Cisco WebEx servers, Google cloud, Microsoft Office 365 cloud, Skype cloud, etc.). Other known network metrics can also be captured, as desired.

The metrics sent to MAM 406 may also differ for different physical areas of the monitored network. For example, the different physical areas may be associated with the locations of different pieces of networking equipment in the network, such as deployed access points. For purposes of illustration, let Mᵢ denote the vector of metrics for area iᵢ that are received and analyzed by MAM 406. In general, Mᵢ includes the status metrics that may be of interest to a network administrator or other user. Note that Mᵢ may also be a superset of metrics that also include other metrics that are not of interest to, or may be otherwise hidden from, the end user/administrator. For example, as detailed below, if the system displays a heatmap of the observed throughput in the network using the adaptive health status techniques herein, the system may also take into account any number of additional metrics that are correlated with the shown throughput but are not actually displayed to the end user.

Status prediction module (SPM) 408 may receive the aggregated metrics 410 (Mᵢ) from MAM 406 as input and outputs a predicted health status score, denoted as Sᵢ herein. In various embodiments, the status score Sᵢ can be a scalar or have multiple components (e.g., for on-boarding/roaming experience, for voice, for video, for browsing, etc.), thus reflecting different aspects of interest to the network administrator. For example, the health status score may indicate a network throughput health status, a roaming health status, interference health status, or the like, regarding the monitored network.

In various embodiments, SPM 408 may maintain a machine learning-based predictive scoring model that uses Mᵢ as an input feature vector and outputs Sᵢ. For example, the scoring model may be a regression model such as a random forest model, deep neural network, or the like, that learns the relationships between these two sets of data. At first, the predictive scoring model of SPM 408 may be trained using labels generated by manually defined health status rules. However, over time, the model may be adjusted automatically and dynamically based on feedback signals from the applications involved, the monitored network, and/or the network administrator.

In one embodiment, the predictive scoring model of SPM 408 may compute the health status score according to the distance with a learned baseline (e.g. outliers) using an unsupervised approach. In another embodiment, the predictive scoring model of SPM 408 may use supervised learning and rely on labels that are collected via explicit signal from either the end user (e.g., a user specified ranking) or implicit signals (e.g., health-related signals from the network such as TCP windows, MAC retries, etc.).

The collection of implicit and/or explicit indicators of the health status as feedback for the machine learning-based predictive scoring model of SPM 408 is another key aspect of the techniques herein. Notably, beyond the monitored metrics used as input to the model itself, there may be other strong indicators of the actual health status of the network that can be used as feedback to adjust the model. In general, such indicators may be implicit if they are obtained directly from the network itself or, alternatively, explicit if specified directly by a network administrator or other user of the network assurance system.

In the case of implicit feedback signals regarding the actual health status of the network, such signals may be collected by network data collection platform 306 in any number of ways and provided to SPM 408 either directly or via MAM 406 (e.g., as part of metrics 410). For example, data collection engine 404 may leverage various protocols (e.g., SNMP, etc.), REST APIs to on-boarded probes (e.g., ILM for wireless, etc.), Netconf, or the like. In other cases, data collection engine 404 may leverage control planes extensions to existing protocols (e.g., 802.11, IGP, etc.), to obtain the implicit feedback signals. For the sake of illustration, the implicit feedback signals may include, but are not limited to, MAC layer retries, TCP/RTCP/etc. window adjustments, back pressure signals, video CODEC dynamic adjustments, QoS signals (e.g., shaping, queues length, Call Admission control, etc.) and the like. In further cases, the implicit feedback may include service quality ratings provided by the users of the client devices in the network. For example, in further cases, data collection engine 404 may also collect call quality ratings from a conferencing server or service in which users rate the perceived call quality of voice and/or video conferences.

In the case of explicit feedback signals, SPM 408 may receive the feedback directly sourced from the network administrator or other user of the network assurance system itself. For example, as shown, SPM 408 may provide visualization data 412 to output and visualization interface 318 for display to a network administrator. In turn, the administrator may provide explicit feedback 414 to SPM 408 about a particular health index, such as by proposing a more relevant one if deemed necessary. For instance, assume that several users in a given building have been impacted by a lack of connectivity at a certain point in time, but the network assurance system indicated via visualization data 412 that this network location was healthy. In such a situation, the network administrator may provide explicit feedback 414 to the network assurance system indicating that the network location was actually unhealthy at that time. This way, the predictive scoring model of SPM 408 will be updated using explicit feedback 414 during its next retraining period, to improve its health score predictions.

In another embodiment, the network administrator may provide explicit feedback 414 using natural language (e.g., written feedback, oral feedback via speech recognition, etc.), thus allowing SPM 408 to adjust its internal model based on sentences such as “Some users are running into problems with their voice-over-IP calls in building 25 since this morning.” The very nature of this type of feedback makes it more fragile and imprecise, but this may be compensated by the fact that the administrator will give feedback more often, thus resulting in more training data for SPM 408.

An active learning mechanism may also be used to request explicit feedback from the network administrator about a given area of the network, which may or may not be healthy. The administrator may then investigate this particular area and determine if the health score is accurate and provide explicit feedback 414 back to the network assurance system.

Another powerful aspect of the techniques herein lies in the way the predicted health status scores for the network are conveyed to the network administrator or other user of the network assurance system. In various embodiments, visualization data 412 may include an indication of the predicted health score for presentation by an electronic display in conjunction with a visualization (e.g., map or other representation) of the physical location in which certain networking equipment is located. For example, in one embodiment, the predicted health status score may be converted into a heatmap that is shown as an overlay for the physical location in which the networking equipment is located. This may be done, e.g., by converting the scalar predicted by SPM 408 into a corresponding color for display in the heatmap.

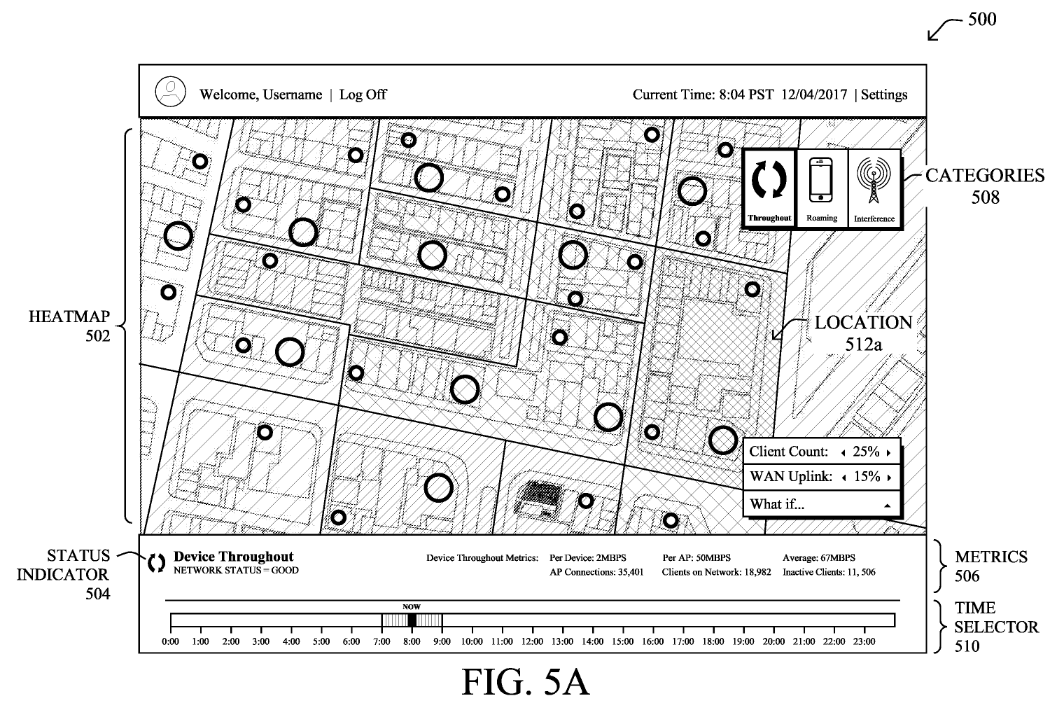

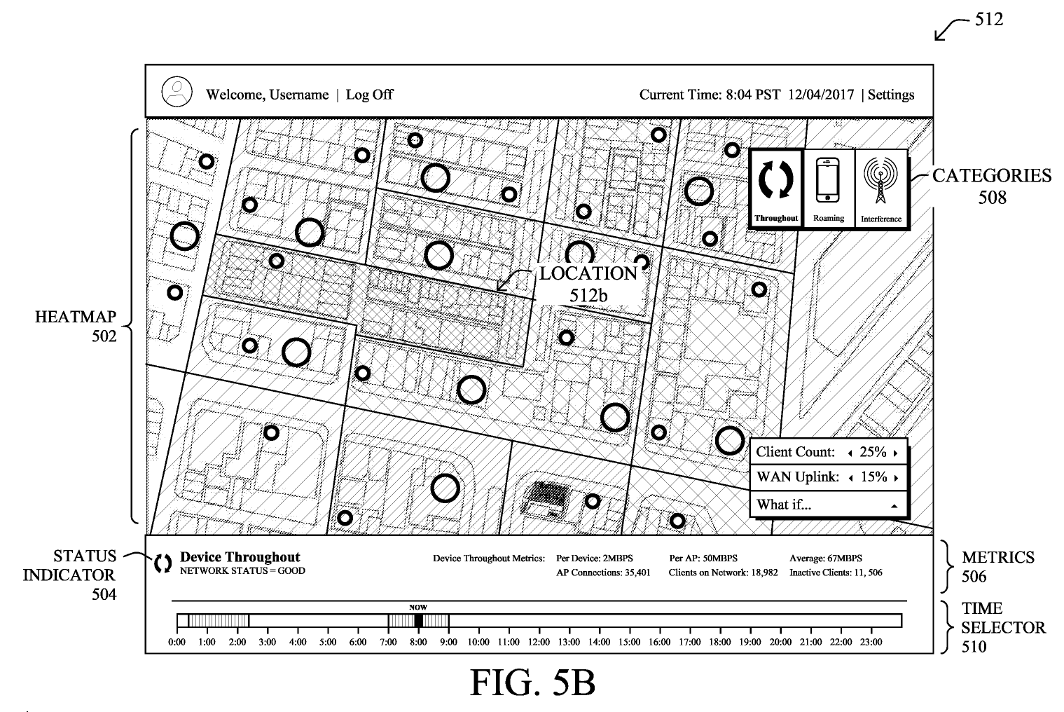

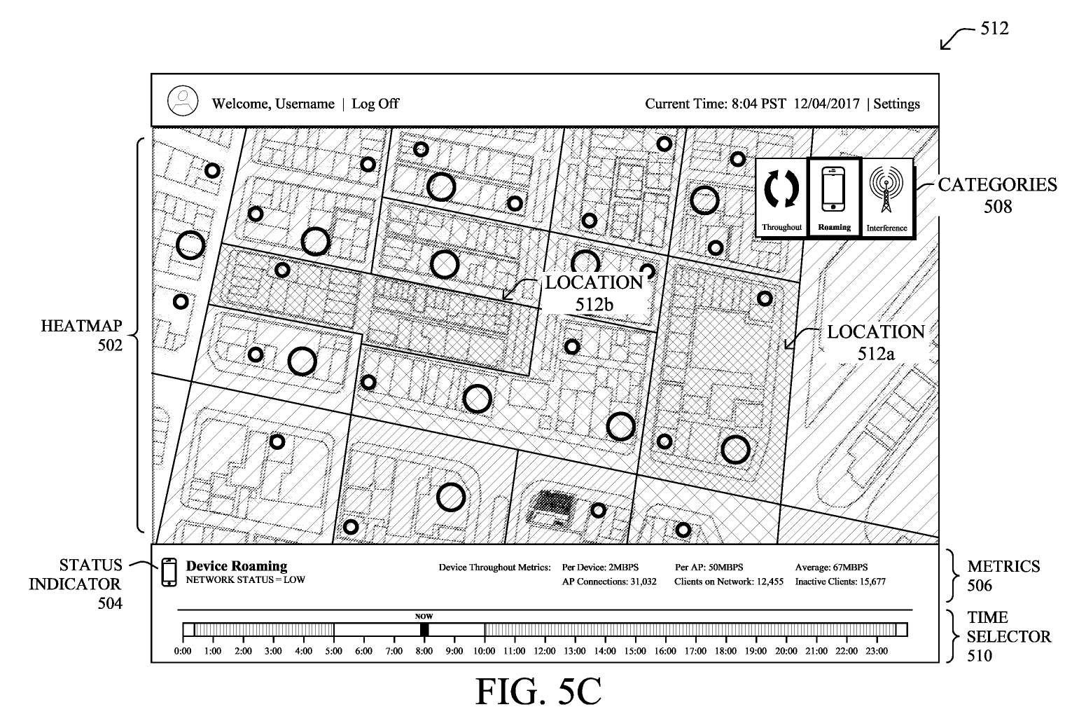

FIGS. 5A-5C illustrate example network assurance visualizations of networking equipment in a physical location. In general, visualization data generated by the network assurance system may be presented on an electronic display to a network administrator or other user as a graphical user interface (GUI). Using this approach, the network administrator can valuate at a glance the health of the whole network, and quickly zoom into areas that seem to be problematic. This visualization would allow the network operator to survey his network very quickly, but also to provide explicit feedback 414 to SPM 408 in a very intuitive fashion, e.g., by selecting an area of the network and picking a corresponding health score that reflects better the actual state of the network at that time.

As shown in the screen capture 500 of FIG. 5A, the network assurance system may present a heatmap 502 to the administrator indicative of the health status of various physical location in which equipment of the network are located. For example, heatmap 502 may include a map of a campus, building, floor, or portion thereof, in which various networking equipment is located. The health of the various locations/networking equipment in those locations may be indicated using a shading as part of heatmap 502. For example, the shading of location 512a may indicate that the health of the access points in that location are exhibiting less than ideal throughput.

The GUI may also include various controls that allow the administrator to visualize the health status of the network across different points in time and/or different categories of health statuses. For example, the GUI may include selectable categories 508 in which the user is able to select a particular type of health status, such as throughput, roaming, or interference. The GUI may further include a time selector 510 that allows the administrator to visualize the prior, present, and/or predicted future health status of the network.

For a given health status category, the GUI may display a status indicator 504 thereby indicating the overall health status of the network. For example, as shown in FIG. 5A, the overall health status of the network in terms of device throughput may be ‘Good’ based on one or more adaptive thresholds of the predictive model. In addition, the GUI may also present various metrics 506 used as part of the prediction (e.g., some of the metrics used as part of input feature vector Mᵢ for the shown location). Doing so affords the administrator greater insight into the health of the network. For example, in the context of throughput, metrics 506 may include statistics regarding the average throughput per client device, per access point (AP), averages, number of AP connections, number of clients, number of inactive clients, etc.

FIG. 5B illustrates another screen capture 514 of a GUI implemented using the techniques herein. In contrast to screen capture 510, heatmap 502 may include different shadings as part of its overlay for different physical locations, based on the predicted health of the networking equipment in those locations. For example, in FIG. 5B, location 512b may be shaded to indicate that the APs in this location are experiencing less than expected throughput, whereas heatmap 502 for location 512a in FIG. 5A may indicate that it is location 512a that is experiencing the reduced throughput.

FIG. 5C illustrates yet another screen capture 516 of a GUI implementing the techniques herein. Here, the GUI has been operated to show the network health in terms of client roaming (e.g., as controlled via categories 508). As conveyed by heatmap 502, both locations 512a and 512b are indicates as having higher than expected client roaming (e.g., clients moving between APs) and the status indicator 504 indicates that the overall predicted health status for the area shown is ‘low.’

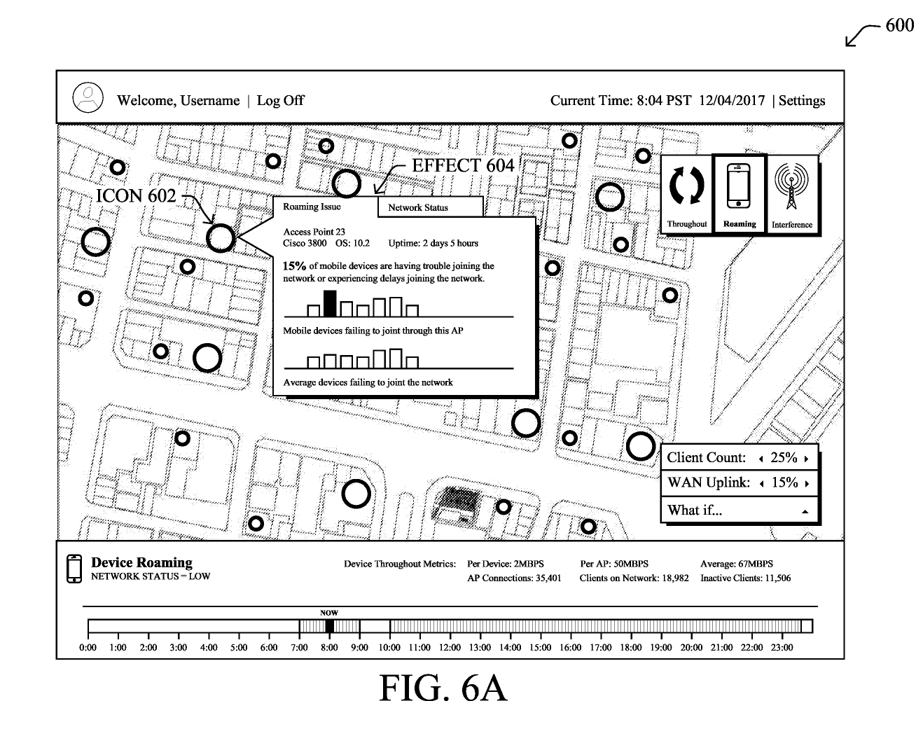

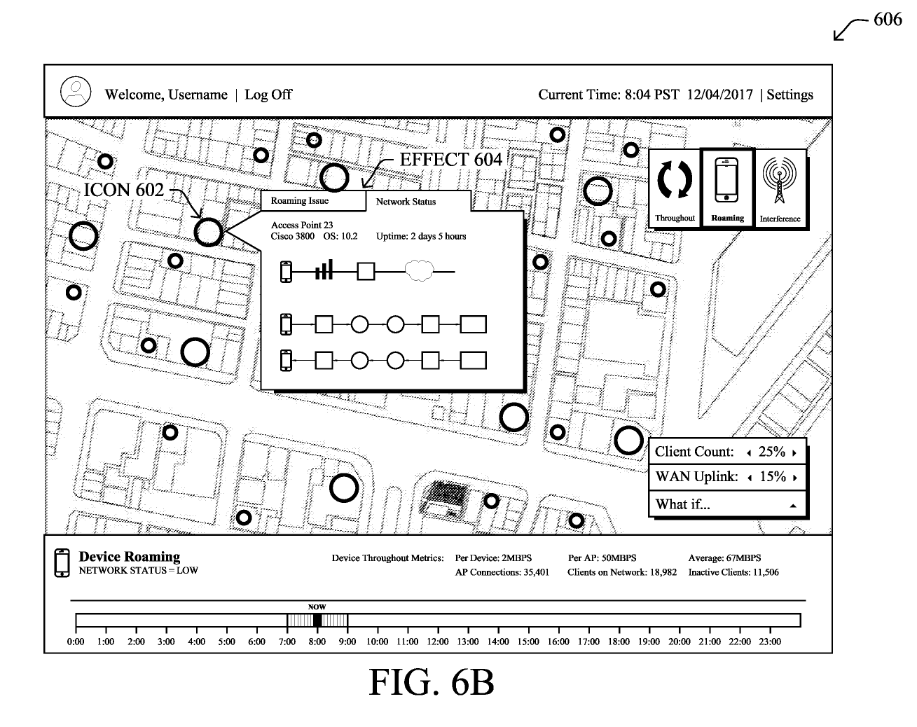

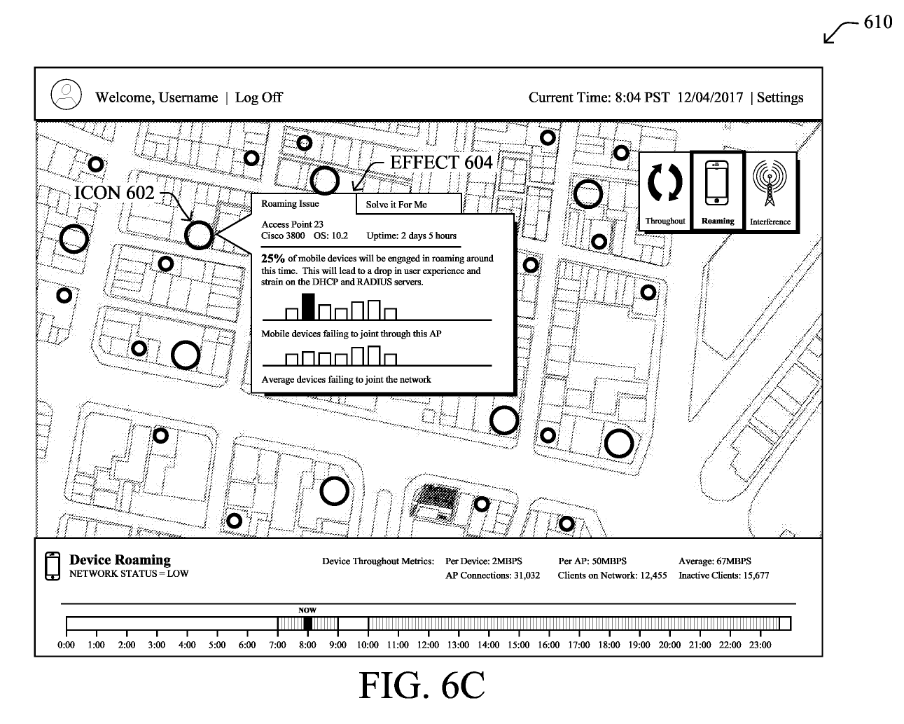

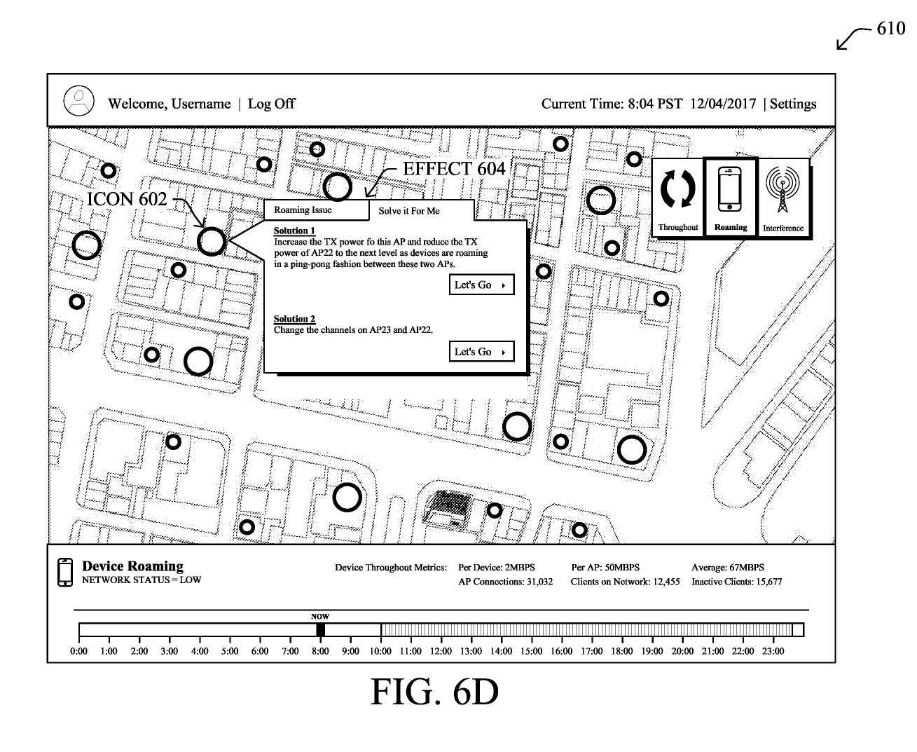

FIGS. 6A-6D illustrate example interactions with a visualized piece of networking equipment in a network assurance system, according to various embodiments. Continuing the examples of FIGS. 5A-5C, the GUI generated by the network assurance system may also allow the user to zoom in on specific locations and perform certain actions with respect to a particular piece of networking equipment. For example, as shown in screen capture 600 in FIG. 6A, AP designated ‘23’ in the network may be represented in the GUI as icon 602. Selection or hovering over icon 602 may then launch effect 604 that conveys additional details about the health of that AP. For example, if the heatmap of the GUI indicates that the AP is experiencing higher than expected roaming (e.g., by an orange or yellow shading in the heatmap), the user of the GUI can then select zoom in on the problematic location and select icon 602 for more information. In the case shown, it may be that 15% of the clients attempting to join the network via the AP are unable to join or are experiencing delays. Note further that the condition may be temporal in nature and effect 604 may also indicate the times at which this condition is present.

In screen capture 606, effect 604 may also convey network status information regarding the roaming issue associated with the AP. Such status information may, for example, convey further details as to why a given client may have problems attaching to the network via the AP. For example, some of the issues may be related to the clients being unable to authenticate via an authentication, authorization, and accounting (AAA) service in the network.

Screen captures 608-610 in FIGS. 6C-6D, respectively, illustrate yet another example of the AP experiencing a roaming issue that affects its health and contributes to a decline in the overall health of the network. For example, as shown in FIG. 6C, effect 604 may indicate that 25% of the mobile devices near the AP between 11:00-12:00AM are predicted to experience roaming. In turn, as shown in greater detail in FIG. 6D, the network assurance system may offer suggested solutions to the administrator via effect 604, such as by adjusting the transmission strengths of the AP and one of its neighbors, so as to prevent clients from switching back and forth between the APs.

As would be appreciated, the examples shown in FIGS. 5A-5C and 6A-6D are exemplary only and the GUI for the network assurance system may indicate the predicted health status in any number of ways such as, but not limited to, icons, text, shadings, colorations, flashing or other optical indicia, sounds, or the like. Further, as noted, the GUI may be configured to receive explicit feedback from the administrative user regarding the perceived health status of the networking equipment in any given location. For example, if the predictive model predicts a low health status in terms of roaming, but the administrator believes the underlying roaming issue to be acceptable, the user may indicate this discrepancy. In turn, the network assurance system may use this feedback during retaining of its predictive model, to adapt its health status predictions to the expectations of the administrator.

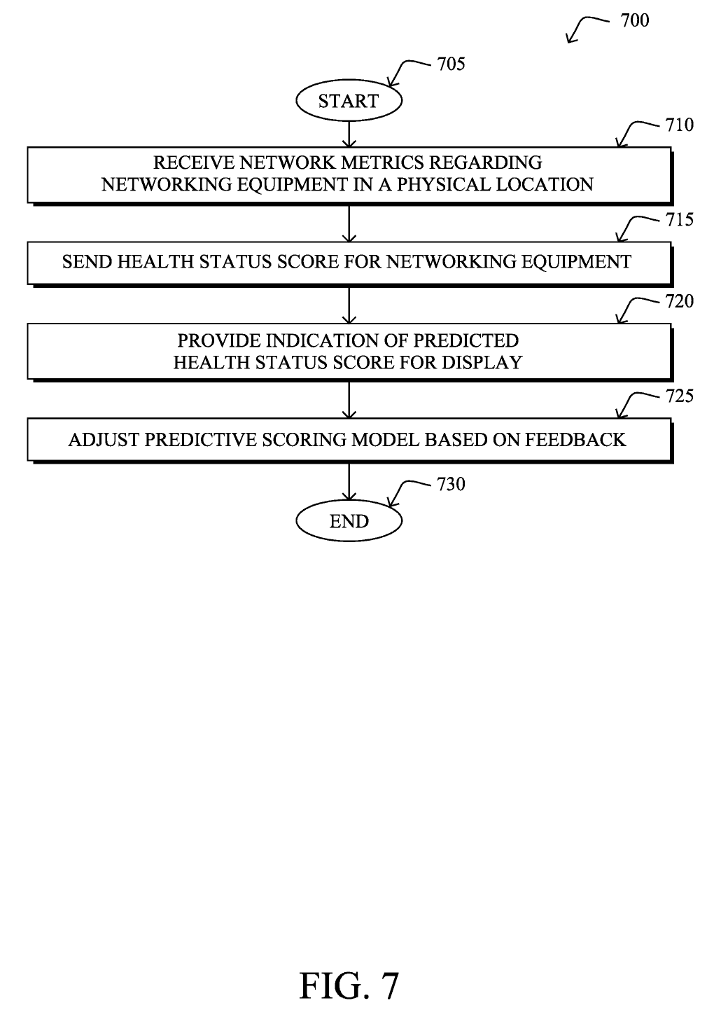

FIG. 7 illustrates an example simplified procedure for adjusting a health score predictive scoring model, in accordance with one or more embodiments described herein. For example, a non-generic, specifically configured device (e.g., device 200) may perform procedure 700 by executing stored instructions (e.g., process 248). The procedure 700 may start at step 705, and continues to step 710, where, as described in greater detail above, the device may receive network metrics regarding networking equipment of a network in a physical location. Such metrics may be of any number of different forms of monitored information regarding the networking equipment, potentially with details down to the client-specific level, application-specific level, etc.

At step 715, as detailed above, the device may predict a health status score for the networking equipment in the physical location using the received network metrics as input to a machine learning-based predictive scoring model. For example, in one embodiment, the model may be a regression model, such as a random forest model or deep neural network. In general, the model may learn the relationships between the input metrics and their corresponding health status scores.

At step 720, the device may provide an indication of the predicted health status score in conjunction with a visualization of the physical location for display by an electronic display, as described in greater detail above. In one embodiment, the device may translate the health status score from its predictive model into a coloration for a heatmap for display to an administrative user (e.g., ranging from green indicating normal health to red to indicate errors, using other ranges of colors, etc.). Doing so would allow the administrative user to quickly assess the health status of the networking equipment in the displayed location and without having to review each of the metrics individually.

At step 725, as detailed above, the device may also adjust the predictive scoring model based on feedback regarding the predicted health status score. Such feedback may be implicit, such as one or more strong indicators of health obtained from the monitored network. Such implicit indicators may include, for example, low call quality ratings by users, MAC layer retries, TCP/RTCP/etc. window adjustments, back pressure signals, video CODEC dynamic adjustments, QoS signals, and the like. In other words, regardless of the predicted health score, there may exist some indicators of a problem in the network. In other cases, the feedback may be explicit, such as originating from the administrator or other user of the network assurance system. For example, the administrator may convey, via natural language feedback, that the predicted health status of a particular location is not correct. In turn, the device may adjust the predictive model, accordingly. For example, in some cases, the device may adjust one or more thresholds of the model (e.g., by altering the health threshold between ‘normal’ and ‘low’ health, etc.). Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for a more flexible and accurate representation of the network health, based in particular on explicit signals such as the application feedback, the user satisfaction and/or the feedback of the network operator.

While there have been shown and described illustrative embodiments that provide for a network assurance system, it is to be understood that various other adaptations and modifications may be made within the spirit and scope of the embodiments herein. For example, while certain embodiments are described herein with respect to using certain models for purposes of evaluating the health of a monitored network, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a device, network metrics regarding networking equipment of a network in a physical location;
predicting, by the device, a health status score for the networking equipment in the physical location using the received network metrics as input to a machine learning-based predictive scoring model;
providing, by the device, an indication of the predicted health status score in conjunction with a visualization of the physical location for display by an electronic display; and
adjusting, by the device, the predictive scoring model based on feedback regarding the predicted health status score.

2. The method as in claim 1, further comprising:
determining, by the device, a health status label by comparing the health status score to one or more thresholds of the predictive scoring model, wherein the indication of the predicted health status score comprises the health status label.

3. The method as in claim 2, wherein adjusting the predictive scoring model based on feedback regarding the predicted health status score comprises:
adjusting, by the device, the one or more thresholds of the predictive scoring model.

4. The method as in claim 1, wherein the health status score indicates at least one of: a network throughput health status, a roaming health status, or an interference health status.

5. The method as in claim 1, wherein providing the indication of the predicted health status score in conjunction with the visualization of the physical location for display by the electronic display comprises:
representing, by the device, the indication of the predicted health status score as a heatmap coloration for the visualization of the physical location.

6. The method as in claim 1, further comprising:
receiving, at the device, the feedback via a user interface.

7. The method as in claim 6, wherein the feedback comprises natural language feedback regarding the physical location.

8. The method as in claim 1, wherein the feedback comprises one or more implicit indicators obtained from the networking equipment.

9. The method as in claim 1, wherein the predictive scoring model comprises a regression model.

10. An apparatus comprising:
one or more network interfaces to communicate with a network;
a processor coupled to the network interfaces and configured to execute one or more processes; and
a memory configured to store a process executable by the processor, the process when executed configured to:
receive network metrics regarding networking equipment of a network in a physical location;
predict a health status score for the networking equipment in the physical location using the received network metrics as input to a machine learning-based predictive scoring model;
provide an indication of the predicted health status score in conjunction with a visualization of the physical location for display by an electronic display; and
adjust the predictive scoring model based on feedback regarding the predicted is health status score.

11. The apparatus as in claim 10, wherein the process when executed is further configured to:
determine a health status label by comparing the health status score to one or more thresholds of the predictive scoring model, wherein the indication of the predicted health status score comprises the health status label.

12. The apparatus as in claim 11, wherein the apparatus adjusts the predictive scoring model based on feedback regarding the predicted health status score by:
adjusting the one or more thresholds of the predictive scoring model.

13. The apparatus as in claim 11, wherein the health status score indicates at least one of:
a network throughput health status, a roaming health status, or an interference health status.

14. The apparatus as in claim 10, wherein the apparatus provides the indication of the predicted health status score in conjunction with the visualization of the physical location for display by the electronic display by:
representing the indication of the predicted health status score as a heatmap coloration for the visualization of the physical location.

15. The apparatus as in claim 10, wherein the process when executed is further configured to:
receive the feedback via a user interface.

16. The apparatus as in claim 15, wherein the feedback comprises natural language feedback regarding the physical location.

17. The apparatus as in claim 10, wherein the feedback comprises one or more implicit indicators obtained from the networking equipment.

18. The apparatus as in claim 10, wherein the predictive scoring model comprises a regression model.

19. A tangible, non-transitory, computer-readable medium storing program instructions that cause a device to execute a process comprising:
receiving, at the device, network metrics regarding networking equipment of a network in a physical location;
predicting, by the device, a health status score for the networking equipment in the physical location using the received network metrics as input to a machine learning-based predictive scoring model;
providing, by the device, an indication of the predicted health status score in conjunction with a visualization of the physical location for display by an electronic display; and
adjusting, by the device, the predictive scoring model based on feedback regarding the predicted health status score.

20. The computer-readable medium as in claim 19, wherein providing the indication of the predicted health status score in conjunction with the visualization of the physical location for display by the electronic display comprises:
representing, by the device, the indication of the predicted health status score as a heatmap coloration for the visualization of the physical location.
